(19) United States
(12) Patent Application Publication
(10) Pub. No.: US 2025/0267224 A1
(43) Pub. Date: Aug. 21, 2025

(54) INFORMATION PROCESSING APPARATUS FOR DETERMINING MASKING TARGET REGIONS, INFORMATION PROCESSING METHOD, AND NON-TRANSITORY STORAGE MEDIUM

(71) Applicant: CANON KABUSHIKI KAISHA, Tokyo (JP)

(72) Inventor: YOHEI OKATANI, Kanagawa (JP)

(21) Appl. No.: 19/049,428

(22) Filed: Feb. 10, 2025

(30) Foreign Application Priority Data
Feb. 19, 2024 (JP) 2024-022656

(51) Int. Cl. H04N 1/00; G06V 10/24; G06V 30/16; G06V 30/412; G06V 30/413

(52) U.S. Cl. CPC H04N 1/00816; G06V 10/242; G06V 30/16; G06V 30/412; G06V 30/413; H04N 1/00824

(57) ABSTRACT

An information processing apparatus includes at least one memory that stores instructions, and at least one processor that executes the instructions to perform extracting a first region as a masking target from a document image based on a predetermined format, extracting a second region as a character string having a masking target attribute from the document image, extracting, in a case where position coordinates of the first region overlap position coordinates of the second region, a third region based on the position coordinates of the first region and the position coordinates of the second region, determining a masking target region in the document image based on the first region, the second region, and the third region, and generating a masked image by masking the determined masking target region on the document image.

### BACKGROUND

### Field

The present disclosure relates to a technique for determining masking target regions from an image.

### Description of the Related Art

When sharing a document including private information and secrets, such as a personal identification document, an application document, and a drawing, the document may be partly redacted to be masked (this action is also referred to as redaction or masking). U.S. Pat. No. 2017/0124347 discloses a technique for masking fixed regions as masking targets and regions where proper nouns appear, at the time of document printing.

The technique disclosed in U.S. Pat. No. 2017/0124347 includes masking fixed regions specific to the type of form as masking targets and regions where masking target character strings appear. The latter regions vary depending on each type of form. Methods for masking fixed regions include a method for storing masking target regions (positions and sizes) and masking the corresponding regions. For example, a driver's license includes predetermined name and address fields, and masking target regions can be identified by setting the positions and sizes of the corresponding fields. As a method for masking regions that vary depending on each type of form, such as “Billing Destination” and “Billing Address”, U.S. Pat. No. 2017/0124347 discloses a method for extracting character strings through Optical Character Recognition (OCR) and extracting and masking regions where proper nouns appear.

However, a method for extracting and masking fixed regions cannot, in some cases, mask some regions where the amount of character strings becomes large enough to exceed pre-estimated regions. A method for extracting and masking regions that vary depending on each type of form cannot, in some cases, accurately mask a region if an Optical Character Recognition (OCR) operation fails because of noise on the form or a logo or seal overlapping a character string.

### SUMMARY

According to an aspect of the present disclosure, an information processing apparatus includes at least one memory that stores instructions, and at least one processor that executes the instructions to perform extracting a first region as a masking target from a document image based on a predetermined format, extracting a second region as a character string having a masking target attribute from the document image, extracting, in a case where position coordinates of the first region overlap position coordinates of the second region, a third region based on the position coordinates of the first region and the position coordinates of the second region, determining a masking target region in the document image based on the first region, the second region, and the third region, and generating a masked image by masking the determined masking target region on the document image.

Further features of the present disclosure will become apparent from the following description of exemplary embodiments with reference to the attached drawings.

### BRIEF DESCRIPTION OF THE DRAWINGS

FIG. 1 illustrates an example of the general configuration of an image processing system.

FIG. 2 illustrates an example of the hardware configuration of a multifunction peripheral (MFP).

FIG. 3 illustrates an example of the hardware configuration of an external storage.

FIG. 4 illustrates an example of a functional configuration of the image processing system.

FIG. 5 is a flowchart illustrating the general processing of the MFP.

FIGS. 6A and 6B illustrate examples of display of screens displayed on an operation unit of the MFP.

FIG. 7 illustrates an example of a correction method.

FIGS. 8A to 8C illustrate examples of screens displayed on the operation unit of the MFP.

FIG. 9 illustrates an example of a screen displayed on the operation unit of the MFP.

### DESCRIPTION OF THE EMBODIMENTS

A first exemplary embodiment will be described with reference to the accompanying drawings.

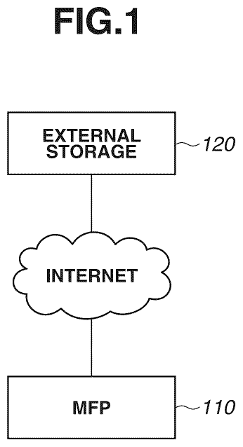

FIG. 1 illustrates an example of the general configuration of an image processing system according to the present exemplary embodiment. An image processing system in FIG. 1 includes a multifunction peripheral (MFP) 110 and an external storage 120. The MFP 110 is communicably connected with a server that provides various services on the Internet via a local area network (LAN).

The MFP 110 is a multifunction peripheral having a plurality of functions, such as a scanner and a printer, and is an example of an information processing apparatus. The MFP 110 also has a function of transferring a scanned image file to a system for storing files, such as an external storage. The information processing apparatus is not limited to an MFP having a scanner and a printer but may be a personal computer (PC).

The external storage 120 is a server system that provides services for receiving, storing, and transmitting files via the Internet in response to a processing request from an external device. For example, the external storage 120 is used in a cloud service. The image processing system is not limited to include one external storage alone but may include a plurality of external storages.

While the image processing system according to the present exemplary embodiment includes the MFP 110 and the external storage 120, the present exemplary embodiment is not limited thereto. For example, the functions and processing of the MFP 110 may be partly shared with another server installed on the Internet or a LAN. The external storage 120 may be installed not on the Internet but on the LAN. The external storage 120 may also be a mail server, and the MFP 100 may attach a scanned image file to an e-mail. The MFP 110 may have a storage function of the external storage 120.

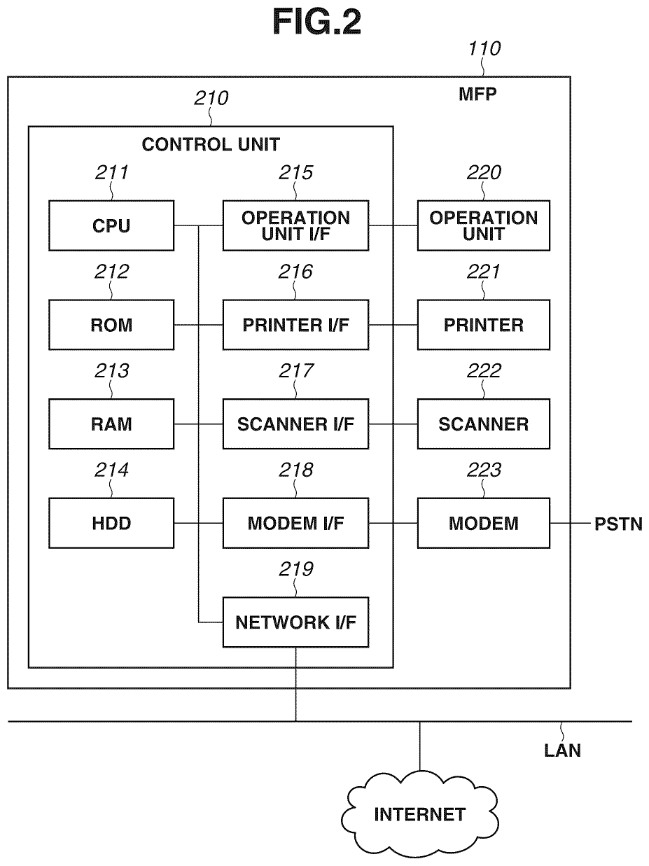

FIG. 2 illustrates an example of a hardware configuration of the MFP 110. The MFP 110 includes a control unit 210, an operation unit 220, a printer 221, a scanner 222, and a modem 223. The control unit 210 including the following units 211 to 219 generally controls the operation of the MFP 110. Various functions of the MFP 110 and processing of the flowcharts (described below) are carried out when the central processing unit (CPU) 211 reads programs stored in a read-only memory (ROM) 212 and a hard disk drive (HDD) 214 into a random access memory (RAM) 213 as a working memory and then executes the programs. The RAM 213 is used as the main memory of the CPU 211 and a temporary storage, such as a working area. While, in the present exemplary embodiment, one CPU 211 executes each piece of processing of the flowchart (described below) using one memory (the RAM 213 or the HDD 214), the present exemplary embodiment is not limited thereto. For example, a plurality of CPUs and a plurality RAMs or HDDs may be cooperatively operated to execute each piece of processing. The HDD 214 is a mass-storage device for storing image data and various programs.

An operation unit interface (I/F) 215 connects the control unit 210 and the operation unit 220. The operation unit 220 including a touch panel display and a keyboard receives operations, inputs, and instructions from the user. A printer I/F 216 connects the control unit 210 and the printer 221. Image data to be printed is transferred from the control unit 210 to the printer 221 via the printer I/F 216 and then printed on a recording medium.

A scanner I/F 217 connects the control unit 210 and the scanner 222. The scanner 222 reads a document placed on a document positioning plate or an auto document feeder (ADF) (not illustrated) to generate image data, and inputs the image data to the control unit 210 via the scanner I/F 217.

The MFP 110 has a function of printing the image data generated by the scanner 222 on the printer 221, or a copy function, and a function of transmitting files or e-mails. A modem I/F 218 connects the control unit 210 and the modem 223. The MFP 110 communicates image data with a facsimile device on a Public Switched Telephone Network (PSTN) using the modem 223. A network I/F 219 connects the control unit 210 to the LAN. The MFP 110 communicates image data and various types of information with an external device (such as the external storage 120) on the Internet via the LAN using the network I/F 219.

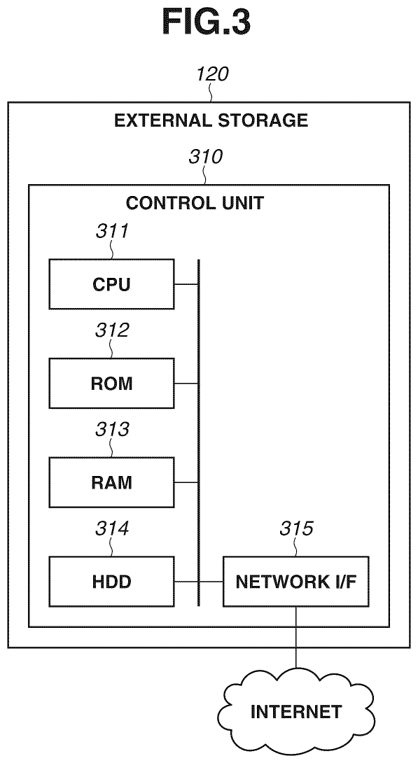

FIG. 3 illustrates an example of a hardware configuration of the external storage 120. The external storage 120 includes a CPU 311, a ROM 312, a RAM 313, an HDD 314, and a network I/F 315. The CPU 311 generally controls the operation of the external storage 120. Various pieces of processing of the external storage 120 is carried out when the CPU 311 reads programs stored in the ROM 312 into the RAM 313 as a working memory and then executes the programs. The RAM 313 is used as the main memory of the CPU 311 and a temporary storage, such as a working area. The HDD 314 is a mass-storage device for storing image data and various kinds of programs. The network I/F 315 connects the external storage 120 to the Internet. The external storage 120 receives a processing request from an external device (such as the MFP 110) via the network I/F 315 and communicates various kinds of information with the external device.

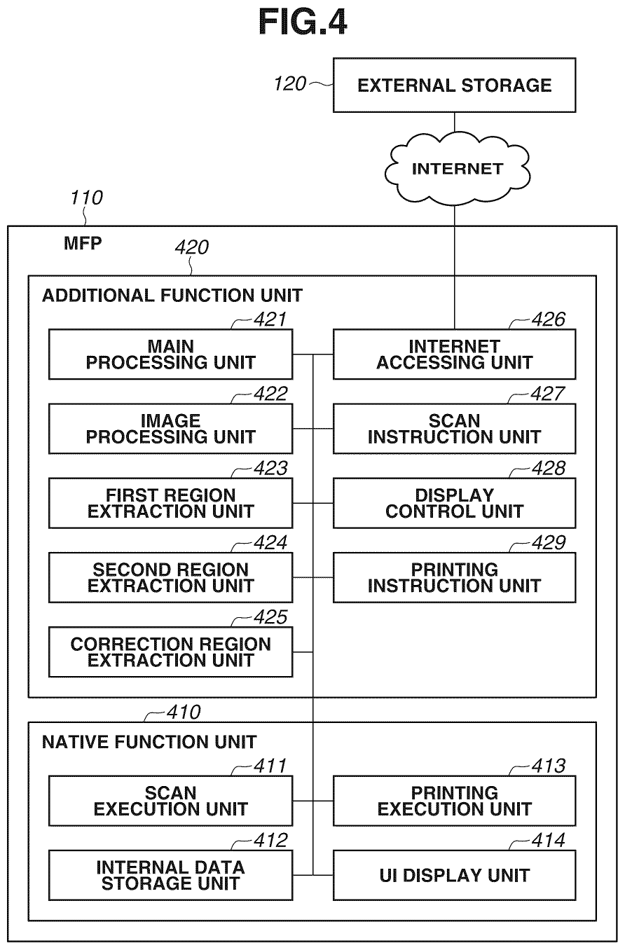

FIG. 4 illustrates an example of a functional configuration of the image processing system according to the present exemplary embodiment. The functions of the units included in a native function unit 410 are standard functions of the MFP 110. On the other hand, the functions of the units included in an additional function unit 420 are functions of an application for transmitting the masked images obtained by masking the masking target regions in a scanned image to the external storage 120 (hereinafter this application is referred to as a masking application). The functions of the native function unit 410 and the additional function unit 420 are carried out when the CPU 211 reads programs including the masking application stored in the ROM 212 or the HDD 214 of the MFP 110 into the RAM 213 and then executes the programs. The masking application is based on Java®, which allows easy addition of functions to the MFP 110. The MFP 110 can have other additional applications installed thereon.

The native function unit 410 includes a scan execution unit 411, an internal data storage unit 412, a printing execution unit 413, and a user interface (UI) display unit 414. The additional function unit 420 includes a main processing unit 421, an image processing unit 422, a first region extraction unit 423, a second region extraction unit 424, a correction region extraction unit 425, an Internet accessing unit 426, a scan instruction unit 427, a display control unit 428, and a printing instruction unit 429.

The main processing unit 421 generally controls the processing of the additional function unit 420 and requests each unit of the additional function unit 420 to execute processing.

The image processing unit 422 performs analysis and processing on image data. The image processing unit 422 performs, on image data, Block Selection (BS), Optical Character Recognition (OCR), image rotation, tilt correction, and other recognition processing. BS is processing for extracting rectangular regions indicating character string positions from an image. OCR is processing for extracting character strings from an image.

The image processing unit 422 also generates a masked image as image data on which the masking regions are masked. Masking regions are masking target regions. The position and size of a masking region are represented by the position coordinates of the starting point (upper left point) and the ending point (bottom right point) of a rectangular region, such as “(441,957), (1369,1057)”. While, according to the present exemplary embodiment, masking regions are rectangular regions, any desired shapes including ovals and triangles are also applicable. A masked image refers to image data on which masking regions are masked. Masking refers to filling masking regions with a chromatic color, such as black or hiding the regions with the background colors. Masking is not limited to specific processing as long as the processing is of preventing character strings in the masking regions from being visually recognized.

The first region extraction unit 423 extracts a first region from image data. The first region includes fixed regions (positions and sizes) predetermined as masking target regions set for each type of form. Examples of the first region include name and address fields of a standard form, such as a driver's license. The first region extraction unit 423 extracts the first region with reference to a predetermined format including predetermined masking target regions. A format list is stored in the HDD 214. The first region extraction unit 423 selects a predetermined format from the format list. The first region extraction unit 423 may select a format corresponding to the type of form, select a format specified by the user, or select a format based on the similarity to image data. The first region extraction unit 423 may also extract a region specified by the user as the first region. The first region extracted by the first region extraction unit 423 is a masking region candidate.

The second region extraction unit 424 extracts a second region from image data. The second region refers to a character string region (position and size) having the attribute of a masking target. Examples of the second region include a personal name described in a free-text field in a questionnaire document, and a company name including a line feed. The second region varies by the piece of image data. The second region extraction unit 424 estimates the character string attribute based on a character string obtained in the OCR, and extracts a character string region having the corresponding attribute as a processing target. Examples of attributes include company name, personal name, address, telephone number, and any other attributes. Methods for estimating character string attributes include a method for using a model obtained by learning character strings provided with known attributes as teacher data. With character strings have a positional relationship between a key and a value on the form layout, there is also a method of estimating the character string being a key as the attribute of the character string being a value. For example, if “Total Amount” is written on the left of “120 yen”, this method estimates “Total Amount” as the attribute of the character string “120 yen”. In this case, the character string being a key may be normalized for use as the attribute. For example, if a character string being a key is “Sum”, this character string is normalized to “Total Amount” for use as the attribute. Other methods for estimating the attribute of a character string are not particularly limited. The second region extracted by the second region extraction unit 424 is a masking region candidate.

If the first region extracted by the first region extraction unit 423 overlaps the second region extracted by the second region extraction unit 424, the correction region extraction unit 425 corrects these regions and extracts the character strings. According to the present exemplary embodiment, the correction region extraction unit 425 collates the position coordinates of the first region extracted by the first region extraction unit 423 with the position coordinates of the second region extracted by the second region extraction unit 424. If the position coordinates of the first and the second regions overlap, the correction region extraction unit 425 recognizes the overlapping region as a correction target region. The correction region extraction unit 425 corrects the correction target region and extracts the corrected region. Applicable correction methods may include a method for taking the logical sum of the position coordinates of the overlapping first and second regions, and a method for taking a circumscribed rectangle having the position coordinates of the overlapping two regions. In addition, a method for excluding regions having no character string from a circumscribed rectangle to reduce the rectangle is also applicable. Other correction methods are not particularly limited. The regions extracted by the correction region extraction unit 425 are masking region candidates.

The Internet accessing unit 426 transmits a processing request to a cloud service that provides a storage function. Generally, cloud services release various interfaces for storing files in cloud storages and acquiring stored files from external devices through Representational State Transfer (REST), Simple Object Access Protocol (SOAP), and other protocols. The Internet accessing unit 426 transmits a processing request to a cloud service using a released interface of the cloud service. According to the present exemplary embodiment, the Internet accessing unit 426 transmits a masked image generated by the image processing unit 422 to the external storage 120 via the network I/F 219.

The scan instruction unit 427 requests the scan execution unit 411 to perform scan processing according to a scan setting input via a UI screen. The UI screen is displayed on the touch panel display of the operation unit 220 under the control of the display control unit 428.

The scan execution unit 411 receives the scan request including the scan setting from the scan instruction unit 427. The scan execution unit 411 controls the scanner 222 via the scanner I/F 217 according to the scan request to read a document placed on the document positioning glass to generate scan image data.

The display control unit 428 controls the display of the UI screen for receiving a user's operations on the liquid crystal display unit (touch panel display) having a touch panel function of the operation unit 220 of the MFP 110. Examples of operations received by the UI screen include an operation for issuing an instruction to make scan settings and start scanning, an operation for specifying masking regions on a preview of a scanned image, and an operation for issuing an instruction to make output settings and start output for a preview of a masked image.

The printing instruction unit 429 transmits a print request corresponding to a print setting input via the UI screen and a masked image to the printing execution unit 413.

The printing execution unit 413 receives the print request including the print setting and the masked image from the printing instruction unit 429. The printing execution unit 413 generates image data for printing according to the print request. According to the generated image data for printing, the printing execution unit 413 controls the printer 221 via the printer I/F 216 to print the masked image on a recording medium.

The internal data storage unit 412 acquires data and stores data in the HDD 214.

The UI display unit 414 displays a menu screen and UI screens for receiving operations for setting and starting various functions, such as the copy function, on the touch panel display of the operation unit 220 of the MFP 110.

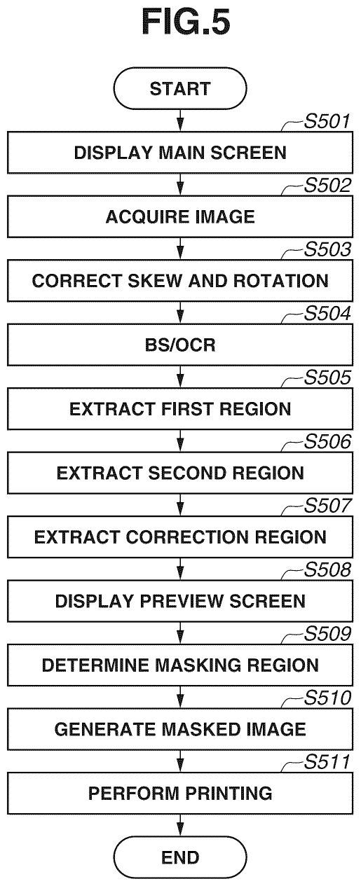

FIG. 5 is a flowchart illustrating the entire processing for generating a masked image based on an image scanned by the MFP 110 and printing the masked image. The processing of this flowchart is carried out when the CPU 211 reads programs including the masking application stored in the ROM 212 or the HDD 214 of the MFP 110 into the RAM 213 and then executes the programs.

This flowchart indicates processing for printing a masked image. However, processing for storing a masked image in a file and transmitting the file to the external storage 120 is also applicable. In the present exemplary embodiment, an example will be described where the display control unit 428 displays UI screens on the touch panel display of the operation unit 220. However, the display control unit 428 may provide UI screens to an external device, displaying the UI screens thereon.

In step S501, the main processing unit 421 requests the display control unit 428 to display a main window of the masking application. The display control unit 428 generates the main window for receiving masking settings and displays the main screen on the touch panel display of the operation unit 220.

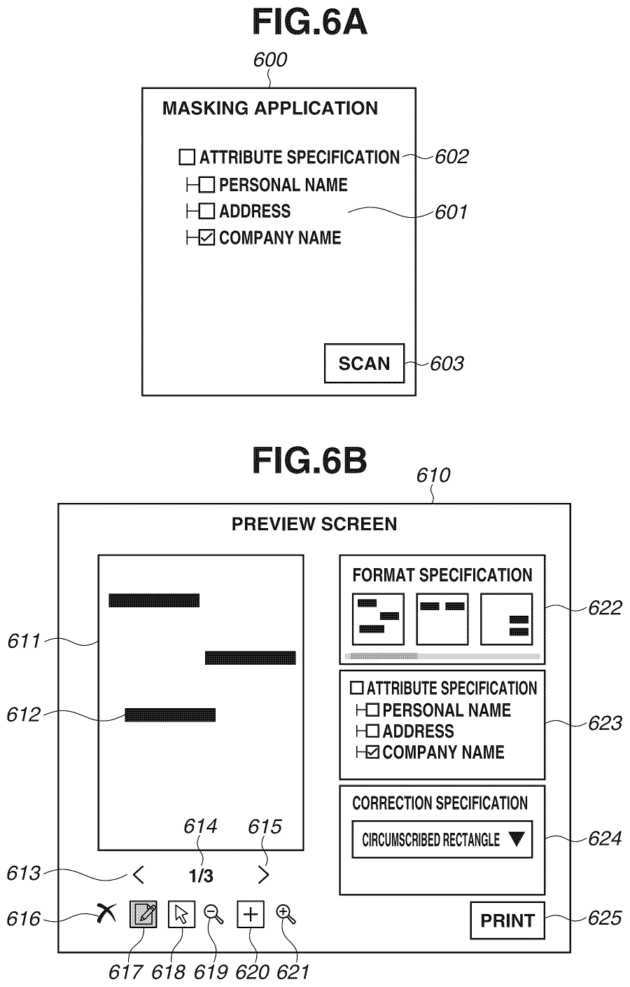

FIG. 6A illustrates an example of the main window according to the present exemplary embodiment. A main window 600 includes attribute specification check boxes 601, an all-attributes selection check box 602, and a Scan button 603.

The attribute specification check boxes 601 are used to specify masking target attributes when extracting regions via the second region extraction unit 424. The attribute specification check boxes 601 receive a selection of masking target attributes from the user. The attribute specification check boxes 601 support the attributes that can be extracted by the second region extraction unit 424. According to the present exemplary embodiment, the attributes selectable by the attribute specification check boxes 601 include personal name, address, company name, and any other attributes. The all-attributes selection check box 602 is used to select or deselect all of the check boxes of the attribute specification check boxes 601. The main processing unit 421 acquires the attribute(s) selected by the attribute specification check boxes 601 as a masking setting. The Scan button 603 is used to issue an instruction to start scanning.

Returning to the description of FIG. 5, in step S502, the main processing unit 421 requests the scan execution unit 411 to perform scanning via the scan instruction unit 427 to acquire image data. While, according to the present exemplary embodiment, the main processing unit 421 acquires the image data read by scanning, image data may be acquired from the HDD 214 via the internal data storage unit 412. The main processing unit 421 may also acquire image data from the external storage 120 via the Internet accessing unit 426. Image data may be acquired by using any other methods.

In step S503, the main processing unit 421 requests the image processing unit 422 to perform skew and rotation correction on the image data acquired in step S502. Through the correction of the image data, the image processing unit 422 generates image data that has gone through the skew and rotation correction.

In step S504, the main processing unit 421 requests the image processing unit 422 to perform BS and OCR processing on the image data generated in step S503. The BS according to the present exemplary embodiment is processing for distinguishing character string regions. By performing BS and OCR processing the image data, the image processing unit 422 extracts character string regions to acquire character strings as a result of the character recognition in the corresponding character string regions. Table 1 illustrates an example of the result of the BS/OCR, i.e., examples of character strings and character string regions extracted as a result of the character recognition. The position and size of each character string region are represented by the position coordinates of the start and the end points of the corresponding rectangular region.

TABLE 1

| Character string | Character string region (coordinates of start |
|---|---|
| (OCR result) | and end points) |
| AAAA Inc. | (141, 161), (397, 345) |
| John | (341, 461), (997, 545) |
| 090-XXXX-2111 | (441, 557), (1369, 653) |

In step S505, the main processing unit 421 requests the first region extraction unit 423 to extract the first region using the character string regions extracted in step S504. The first region extraction unit 423 extracts the first region using the character string regions. Firstly, the first region extraction unit 423 acquires the format list from the external storage 120 via the Internet accessing unit 426. The first region extraction unit 423 may acquire the format list from the HDD 214 via the internal data storage unit 412 or by using any other methods. A format includes a character string region or character string regions and a masking target region or masking target regions in a form. The position and size of a character string region and a masking target region in a form are represented by the position coordinates of the start and the end points of the corresponding rectangular region.

Subsequently, the first region extraction unit 423 compares the position coordinates of a character string region of each format in the format list with the position coordinates of a character string region extracted in step S504 to select the format having the highest similarity. In this case, the similarity may be based on the result of the calculation of the overlapping area of character string regions, and is not particularly limited. Table 2 illustrates examples of formats determined to have similar position coordinates of character string regions to the position coordinates of the character string regions illustrated in Table 1. In the corresponding format, the position coordinates of masking target regions are predetermined. The first region extraction unit 423 selects the masking target regions predetermined in the selected format, as the first region.

TABLE 2

| | Masking target region (coordinates of start |
|---|---|
| Character string region | and end points) |
| (141, 161), (397, 345) | (141, 161), (497, 300) |
| (341, 461), (997, 545) | |
| (441, 557), (1369, 653) | |

In step S506, the main processing unit 421 requests the second region extraction unit 424 to extract the second region based on the masking setting (attribute information specified as masking targets) acquired in step S501 and the position coordinates of the character string regions and the character strings as a result of the character recognition acquired in step S504. The second region extraction unit 424 extracts the second region using the masking setting, the character strings, and the character string regions. Firstly, the second region extraction unit 424 estimates the attribute of each character string. For example, the second region extraction unit 424 estimates a character string representing a company name, such as AAAA Inc. as the attribute company name. The following Table 3 illustrates examples of attributes estimated for the character strings and character string regions illustrated in Table 1.

TABLE 3

| Character string | Character string region (coordinates | |
|---|---|---|
| (OCR result) | of start and end points) | Attribute |
| AAAA Inc. | (141, 161), (397, 345) | Company |
| | | name |
| John | (341, 461), (997, 545) | Personal |
| | | name |
| 090-XXXX-2111 | (441, 557), (1369, 653) | Telephone |
| | | No. |

Subsequently, the second region extraction unit 424 extracts a character string region having an attribute specified by the masking setting as the second region. For example, if the attribute specified by the masking setting is company name, the second region extraction unit 424 extracts the character string region AAAA Inc. having the attribute company name as the second region.

While, in the present exemplary embodiment, the second region is extracted after the extraction of the first region, the first region may be extracted after the extraction of the second region, or the first and the second regions may be extracted in parallel.

In step S507, the main processing unit 421 requests the correction region extraction unit 425 to merge to extract overlapping regions between the first region extracted in step S505 and the second region extracted in step S506. The correction region extraction unit 425 compares the position coordinates of the first and the second regions and, if an overlapping region exists between the first and the second regions, performs correction to merge the overlapping first and second regions.

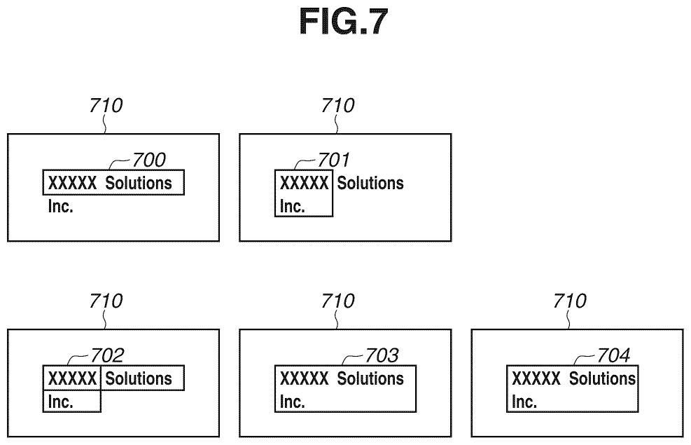

An example of a correction method will be described with reference to examples of character strings described in different documents as illustrated in FIG. 7. FIG. 7 illustrates examples of extracted regions 700 and 701 extracted from an image 710 as an enlarged part of the document. The region 700 is an example of the first region (an example of a masking region predetermined in a certain format). The region 701 is an example of the second region (an example of a character string region selected based on an estimated attribute). A part of region 700 overlaps a part of the region 701.

The region 700 includes the first line XXXXX Solutions but does not include the second line Inc. generated by a line feed. The region 700 includes a blank portion (a portion having no character string) on the right-hand side in the region 700. The region 700 is a region pre-defined on the assumption that a company name is written in a single line. Thus, the character string region in the second line generated by a line feed is outside the region 700 and has not been extracted.

The region 701 includes XXXXX Inc. but does not include Solutions written on the right-hand side of the space. Solutions at the right end of the first line is handled as a different string region at the time of the region extraction in the BS/OCR, so that the character string region XXXXX Inc. having the attribute company name has been extracted. More specifically, the region 701 does not include Solutions at the right end of the first line but includes Inc. in the second line.

Examples of three different methods for correcting the regions 700 and 701 will be described. Desirably, the user can specify which correction method is to be used to correct regions.

A region 702 indicates a region corrected by a method for taking the logical sum of the regions 700 and 701. By the method for taking the logical sum, the regions not extracted by the first and the second region extraction are complemented with each other, and all of the character string regions are included in the region 702.

A region 703 indicates a region corrected by a method for taking a circumscribed rectangle including the regions 700 and 701. By the method for taking a circumscribed rectangle, like the method for taking the logical sum, the regions not extracted by the first and the second region extraction are complemented with each other, and all of the character string regions are included in the region 703. In addition, the regions 700 and 701 are included in the region 703, and the positions and sizes of these regions are hidden, making it hard to estimate the number of character strings based on the size of the region 703.

A region 704 indicates a region corrected by a method for reducing the circumscribed rectangle including the regions 700 and 701. With the method for reducing the rectangle, like the method for taking the logical sum, the regions not extracted by the first and the second region extraction are complemented with each other, and all of the character string regions are included in the region 704. In addition, the region having no character string is excluded, making it possible to reduce useless masking regions.

Table 4 illustrates examples of regions corrected by applying the three different correction methods (the method for taking the logical sum, the method for taking a circumscribed rectangle, and the method for reducing the rectangle) described above with reference to the regions 702 to 704 in FIG. 7 to the first region (masking target region) illustrated in Table 2 and the second region (character string region having the attribute company name) illustrated in Table 3. As illustrated in Table 2, the correction region extraction unit 425 determines the position coordinates of the region obtained by merging the first and the second regions by using the position coordinates of the first and the second regions.

TABLE 4

| Correction | | First | Second |
|---|---|---|---|
| method | Corrected region | region | region |
| Logical sum | ((141, 161), (497, 300)), | (141, 161), | (141, 161), |
| | ((141, 301), (397, 345)) | (497, 300) | (397, 345) |
| Circumscribed | (141, 161), (497, 345) | (141, 161), | (141, 161), |
| rectangle | | (497, 300) | (397, 345) |
| Reduction | (141, 161), (397, 345) | (141, 161), | (141, 161), |
| | | (497, 300) | (397, 345) |

Returning to the description of the flowchart in FIG. 5, in step S508, the main processing unit 421 requests the display control unit 428 to generate a preview screen based on the image data generated in step S503, the first region extracted in step S505, the second region extracted in step S506, and the regions corrected in step S507. The display control unit 428 generates a preview screen for superposing rectangular items in accordance with the position coordinates of the first region, the second region, and the corrected region on the image data generated in step S503, and displays the preview screen on the touch panel display of the operation unit 220.

FIG. 6B illustrates the preview screen according to the present exemplary embodiment. A preview screen 610 includes a preview display region 611, preview masking regions 612, a previous page button 613, a page count display 614, and a next page button 615. Also, the preview screen 610 also includes a masking release button 616, a region selection button 617, a region instruction button 618, a display reduction button 619, a display fitting button 620, and a display enlargement button 621. The preview screen 610 yet includes a format specification form 622, an attribute specification form 623, a correction specification form 624, and a Print button 625.

The preview display region 611 displays the image data generated in step S503.

The preview masking regions 612 are regions displaying the first region extracted in step S505, the second region extracted in step S506, the regions corrected in step S507, and the region specified by the region instruction button 618 (described below), as masking region candidates. The display control unit 428 superposes rectangular items for masking (e.g., black) on the preview masking regions 612 to prevent the character strings on the image data in the preview masking regions 612 from being visibly recognized in the preview display region 611. The preview masking regions 612 superposed on the image data in are displayed in the preview display region 611, making it possible to show the user the result of image masking and have the user check the result before printing.

The previous page button 613 displays image data on the previous page in a plurality of pages constituting image data. The page count display 614 displays the currently displayed page number and the total number of pages of the image data. The next page button 615 displays image data on the next page in a plurality of pages constituting image data.

The masking release button 616 is used to exclude the currently selected region from among the preview masking regions 612 from the masking region candidates. The region selection button 617 is used to select one of the preview masking regions 612. When the display control unit 428 detects a press of one of the preview masking regions 612 in a state where the region selection button 617 is selected, the display control unit 428 determines that the corresponding region is selected for the next operation. When the display control unit 428 detects a press of the masking release button 616, the display control unit 428 hides the rectangular item corresponding to the currently selected region and then excludes the currently selected region from the targets of the preview masking regions 612.

The region instruction button 618 is used to generate a new masking region candidate through a user operation. With the region instruction button 618 selected, the display control unit 428 detects the position touched by a finger as the start point and then the position where the finger is released after dragging as the end point on the preview display region 611, and sets the rectangular region specified with the start and the end points as a new masking region candidate. The display control unit 428 adds the rectangular region specified with the region instruction button 618 to the targets of the preview masking regions 612, and superposes a rectangular item in accordance with the position coordinate of the corresponding rectangular region on the image data.

The display reduction button 619 is used to reduce the display magnification of the preview display region 611 by a fixed amount to display a reduced region. The display fitting button 620 is used to select the maximum display magnification to fit image data into the preview display region 611. The display enlargement button 621 increases the display magnification of the preview display region 611 by a fixed amount to display an enlarged region.

The format specification form 622 is used to select any desired format from the format list acquired in step S505, through a user operation. The format specification form 622 displays masking target regions in different formats in the format list. If the format list does not fit into the display region, a scroll bar is automatically displayed. In the format list, the format selected in step S505 is currently selected, and the other formats are deselected.

When the display control unit 428 detects a press of one of the deselected formats in the format specification form 622, the display control unit 428 makes the corresponding format pre-selected. Then, the display control unit 428 hides the rectangular item(s) corresponding to the masking target region(s) in the selected format, and displays the rectangular item(s) in accordance with the position coordinates of the masking target region(s) in the pre-selected format in a transparent manner. When the display control unit 428 detects a press of the pre-selected format, the display control unit 428 excludes the masking target region(s) in the selected format from the targets of the preview masking regions 612 and deselects the corresponding format. Then, the display control unit 428 selects the pre-selected format, adds the masking target region(s) in the corresponding format to the targets of the preview masking regions 612, and superposes a rectangular item or rectangular items in accordance with the position coordinates of the corresponding region(s) on the image data.

When the display control unit 428 detects a press of a format other than the corresponding format with another format pre-selected, the display control unit 428 deselects the corresponding pre-selected format and hides the rectangular item(s) corresponding to the masking target region(s) in the corresponding format. Then, the display control unit 428 displays a rectangular item or rectangular items in accordance with the position coordinates of the masking target region(s) in the selected format.

The attribute specification form 623 is used to specify again the attribute specified in step S501. The attribute specification form 623 displays the attribute specification check boxes 601 and the all-attributes selection check box 602 having similar functions to the main window 600. When the display control unit 428 detects a press of one of the attribute specification check boxes 601 or the all-attributes selection check box 602, and then an attribute or attributes are selected, the display control unit 428 acquires a character string region or character string regions having the corresponding attribute(s) based on the result of the character string attribute estimation, and displays the corresponding character string region(s) as the targets of the preview masking regions 612. If the attribute selection is cleared, the display control unit 428 excludes the character string region(s) having the corresponding attribute(s) from the targets of the preview masking regions 612.

The correction specification form 624 is used to specify a correction method used in step S507 via a user's operation. The correction specification form 624 is provided with a pull-down menu from which “Logical Sum”, “Circumscribed Rectangle”, or “Reduction” can be selected as the correction method described above with reference to FIG. 7B. The correction methods displayed in the pull-down menu are not limited to “Logical Sum”, “Circumscribed Rectangle”, and “Reduction”. When the display control unit 428 detects a selection of one of the correction methods from the pull-down menu, the display control unit 428 excludes the regions corrected in step S507 among the preview masking regions 612 from the targets of the preview masking regions 612. Then, the correction region extraction unit 425 corrects the regions excluded from the targets of the preview masking regions 612 using the selected correction method. The display control unit 428 displays the regions re-corrected by the correction region extraction unit 425 as targets of the preview masking regions 612.

Returning to the description of FIG. 5, in step S509, when the main processing unit 421 detects a press of the Print button 625, the main processing unit 421 determines the displayed preview masking regions 612 as masking regions. The Print button 625 is used to issue an instruction to start printing the masked image generated by subjecting the image data generated in step S503 to masking of the determined masking region.

In step S510, the main processing unit 421 requests the image processing unit 422 to generate a masked image based on the masking regions determined in step S509 and the image data generated in step S503. The image processing unit 422 masks the rectangular regions generated at the same position coordinates of the masking regions on the image data generated in step S503, to generate a masked image.

In step S511, the main processing unit 421 requests the printing instruction unit 429 to print the masked image generated in step S509. The printing instruction unit 429 prints the masked image via the printing execution unit 413. While, according to the present exemplary embodiment, the main processing unit 421 generates a print product of the masked image through printing, the main processing unit 421 may store the masked image in the HDD 214 via the internal data storage unit 412. The main processing unit 421 may store the masked image in the external storage 120 via the Internet accessing unit 426 or send an e-mail with the masked image attached thereto to any desired destination. This completes a series of processing of this flowchart.

The present exemplary embodiment enables extracting fixed regions as masking targets predetermined for each document format (first extraction), extracting regions where character strings with masking target attributes appear (second extraction), and correcting and extracting the overlapping regions as a result of the first and the second extractions. A region where a character string that goes beyond a fixed region due to a line feed input when a character string is written in an entry field is not extracted in the first extraction can be a masking target through correction with a result of the second extraction. Further, in the second extraction, a region where a part of a character string with a masking attribute, such as company name, is not extracted due to incorrect recognition of the part as noise through OCR processing or a different character string can be a masking target through correction with a result of the first extraction. In the way, even if masking regions include a fixed region or fixed regions specific to each type of form and a region or regions variable depending on each type of form, such as a form including name and address fields and a free-text field, a masking target region or masking target regions can be accurately extracted and masked.

A second exemplary embodiment will be described centering on a method for displaying a rectangular item or rectangular items to be displayed in accordance with the position coordinates of a masking region candidate or masking region candidates on image data in a preview screen, in a distinguishable manner by the extraction type. In the description of the present exemplary embodiment, a description will be omitted for the same configurations and processing as those of the first exemplary embodiment, and only differences will be described.

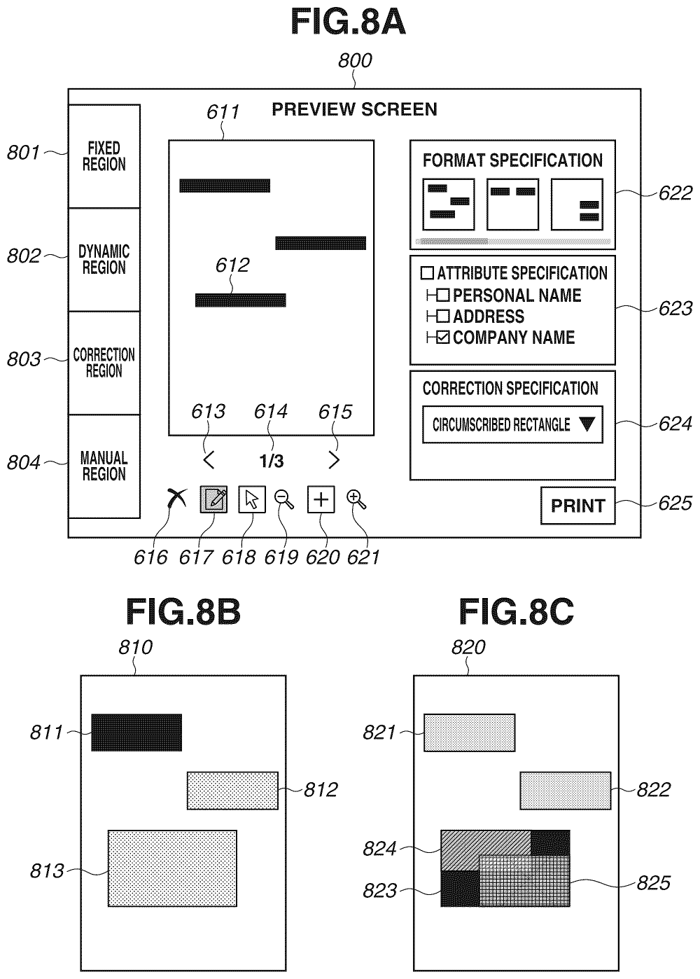

FIG. 8A illustrates a preview screen according to the present exemplary embodiment. According to the present exemplary embodiment, in step S508 of the flowchart in FIG. 5, the display control unit 428 generates the preview image illustrated in FIG. 8A and displays the preview image on the touch panel display of the operation unit 220. In addition to the preview screen 610 in FIG. 6B, a preview screen 800 includes a fixed region layer tab 801, a dynamic region layer tab 802, a correction region layer tab 803, and a manual region layer tab 804. According to the present exemplary embodiment, the preview masking regions 612 are classified into layers depending on the type. More specifically, the first region extracted in step S505 is classified as the fixed region layer, the second region extracted in step S506 as the dynamic region layer, the regions corrected in step S507 as the correction region layer, and a region generated by a user's operation as the manual region layer. The display control unit 428 groups the preview masking regions 612 by the layer to display them.

The fixed region layer tab 801 is used to highlight the regions classified as the fixed region layer among the preview masking regions 612. When the display control unit 428 detects a press of the fixed region layer tab 801, the display control unit 428 determines the fixed region layer to be selected. Alternatively, when the display control unit 428 detects a press of one of the preview masking regions 612 and the corresponding region is the first region extracted in step S505, the display control unit 428 determines the fixed region layer to be selected. With the fixed region layer selected, the display control unit 428 emphasizes the regions classified as the fixed region layer or displays the regions classified as non-fixed region layers in an unnoticeable form. With the fixed region layer selected, the display control unit 428 displays the format specification form 622 and hides the attribute specification form 623 and the correction specification form 624. Alternatively, the display control unit 428 causes an operation on the format specification form 622 to be receivable and an operation on the attribute specification form 623 and the correction specification form 624 to be unreceivable. With the fixed region layer selected, the display control unit 428 emphasizes the region(s) classified as the fixed region layer and displays the format specification form 622 for correcting the region(s) classified as the fixed region layer.

An example of a method for highlighting the region(s) classified as the currently selected layer according to the present exemplary embodiment will be described with reference to FIG. 8B. FIG. 8B illustrates an example of display of a preview display region 810 with the fixed region layer selected. The preview display region 810 includes a fixed region 811, a dynamic region 812, and a correction region 813. The fixed region 811 is an example of the first region extracted in step S505. The dynamic region 812 is an example of the second region extracted in step S506. The correction region 813 is an example of the regions corrected in step S507. With the fixed region layer selected, the display control unit 428 displays a rectangular item in the fixed region 811 in a non-transparent form, and displays rectangular items in the dynamic region 812 and the correction region 813 in a transparent form. The display method is not particularly limited as long as the method emphasizes the fixed region 811 to a further extent than the dynamic region 812 and the correction region 813.

Returning to the description of FIG. 8A, the dynamic region layer tab 802 is used to highlight the region(s) classified as the dynamic region layer among the preview masking regions 612. When the display control unit 428 detects a press of the dynamic region layer tab 802, the display control unit 428 determines the dynamic region layer to be selected. Alternatively, when the display control unit 428 detects a press of one of the preview masking regions 612 and the corresponding region is the second region extracted in step S506, the display control unit 428 determines the dynamic region layer to be selected. With the dynamic region layer selected, the display control unit 428 emphasizes the region(s) classified as the dynamic region layer or displays the region(s) classified as non-dynamic region layers in an unnoticeable form.

With the dynamic region layer selected, the display control unit 428 displays the attribute specification form 623 and hides the format specification form 622 and the correction specification form 624. Further, the display control unit 428 causes an operation on the attribute specification form 623 to be receivable and an operation on the format specification form 622 and the correction specification form 624 to be unreceivable. With the dynamic region layer selected, the display control unit 428 emphasizes the region(s) classified as the dynamic region layer and displays the attribute specification form 623 for correcting the region(s) classified as the dynamic region layer.

The correction region layer tab 803 is used to highlight the region(s) classified as the correction region layer among the preview masking regions 612. When the display control unit 428 detects a press of the correction region layer tab 803, the display control unit 428 determines the correction region layer to be selected. Alternatively, when the display control unit 428 detects a press of one of the preview masking regions 612 and the corresponding region is the regions corrected in step S507, the display control unit 428 determines the correction region layer to be selected. With the correction region layer selected, the display control unit 428 emphasizes the region(s) classified as the correction region layer or displays the region(s) classified as non-correction region layers in an unnoticeable form. With the correction region layer selected, the display control unit 428 displays the correction specification form 624 and hides the format specification form 622 and the attribute specification form 623. Alternatively, the display control unit 428 causes an operation on the correction specification form 624 to be receivable and an operation on the format specification form 622 and the attribute specification form 623 to be unreceivable. With the correction region layer selected, the display control unit 428 emphasizes the region(s) classified as the correction region layer and displays the correction specification form 624 for correcting the region(s) classified as the correction region layer.

FIG. 8C illustrates an example of display with the correction region layer selected according to the present exemplary embodiment. FIG. 8C illustrates an example of display of a preview display region 820 with the correction region layer selected. The preview display region 820 includes a fixed region 821, a dynamic region 822, a correction region 823, a fixed region 824 in the correction region 823, and a dynamic region 825 in the correction region 823. The fixed region 821 is an example of the first region extracted in step S505. The dynamic region 822 is an example of the second region extracted in step S506. The correction region 823 is an example of the region corrected in step S507.

The fixed region 824 in the correction region 823 is a region derived from the first region in the correction region 823. The dynamic region 825 in the correction region 823 is a region derived from the second region in the correction region 823. The display control unit 428 displays rectangular items in the fixed region 821 and the dynamic region 822 in a transparent form.

The display control unit 428 displays the fixed region 824 in the correction region 823 and the dynamic region 825 in the correction region 823 in a distinguishable form. For example, the display control unit 428 displays the fixed region 824 in the correction region 823 and the dynamic region 825 in the correction region 823 in different colors. This enables the display control unit 428 to emphasize the correction region 823 and distinguishably display the fixed region 824 and the dynamic region 825 included in the correction region 823. When the display control unit 428 detects a press of the fixed region 824 in the correction region 823 or the dynamic region 825 in the correction region 823, the display control unit 428 changes the display to the corresponding layer.

Returning to the description of FIG. 8A, the manual region layer tab 804 is used to highlight the region(s) classified as the manual region layer among the preview masking regions 612. When the display control unit 428 detects a press of the manual region layer tab 804, the display control unit 428 determines the manual region layer to be selected. Further, when the display control unit 428 detects a press of one of the preview masking regions 612 and the corresponding region is a region generated by a user's operation, the display control unit 428 determines the manual region layer to be selected. With the manual region layer selected, the display control unit 428 emphasizes the region(s) classified as the manual region layer or displays the region(s) classified as non-manual region layers in an unnoticeable form. With the manual region layer selected, the display control unit 428 hides the format specification form 622, the attribute specification form 623, and the correction specification form 624. Alternatively, the display control unit 428 causes an operation on the format specification form 622, the attribute specification form 623, and the correction specification form 624 to be unreceivable.

The fixed region layer tab 801, the dynamic region layer tab 802, the correction region layer tab 803, and the manual region layer tab 804 may not be tabs but switches. Layers may be displayed in a superposed form.

According to the present exemplary embodiment, on the preview screen for superposing the region(s) extracted as a masking region candidate or masking region candidates on an image, the display control unit 428 can distinguishably display the region(s) extracted as the masking region candidate(s) by the type of extraction method, thus reducing the load on a user's confirmation work. In addition, a suitable correction method is shown for each type of extracting method, enabling the user to easily correct the region(s) extracted as the masking region candidate(s).

A third exemplary embodiment will be described centering on a method for collecting data corresponding to a region or regions extracted as a masking region candidate or masking region candidates by the extraction type. In the description of the present exemplary embodiment, descriptions will be omitted for the same configurations and processing as those of the first exemplary embodiment, and only differences will be described.

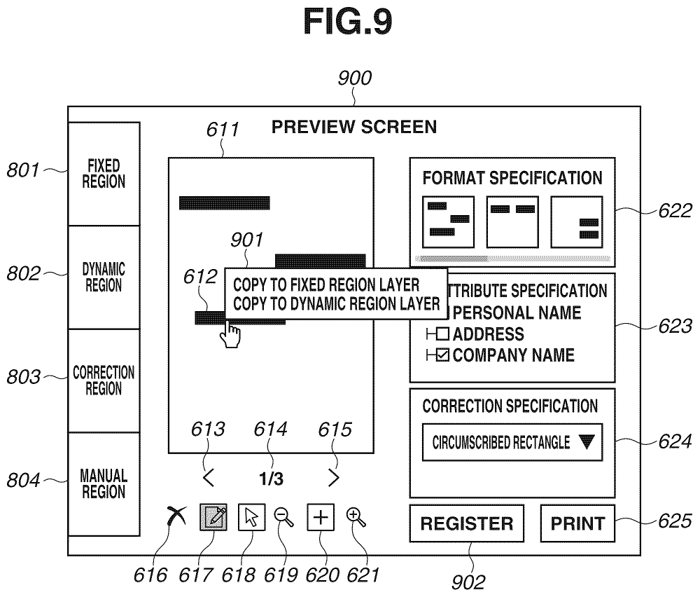

FIG. 9 illustrates a preview screen according to the present exemplary embodiment. According to the present exemplary embodiment, in step S508 of the flowchart in FIG. 5, the display control unit 428 generates the preview image illustrated in FIG. 9 and displays the preview image on the touch panel display of the operation unit 220. A preview screen 900 includes a context menu 901 and a Register button 902 in addition to the preview screen 800 in FIG. 8A.

The context menu 901 is a UI for replicating a selected region as a region of the fixed region layer or as a region of the dynamic region layer. When the display control unit 428 detects a press of one of the preview masking regions 612, the display control unit 428 displays the context menu 901 on the preview screen 900. The display control unit 428 may display the context menu 901 when the display control unit 428 detects a predetermined operation, such as a long-press operation or a double-tap operation, not a short-press operation. The context menu 901 selectively displays an item for issuing an instruction to replicate the selected region as a region of the fixed region layer and an item for issuing an instruction to replicate the selected region as a region of the dynamic region layer.

When either of the items of the context menu 901 is specified, the display control unit 428 replicates the selected region according to the specified item. For example, when the “Copy to Fixed Region Layer” is specified, the display control unit 428 replicates the selected region as a region of the fixed region layer. This enables additionally collecting regions that have not been extracted by a certain extraction method but by another one, as data for accuracy improvement. For example, if, with an increased number of lines, a region not extracted in the first region extraction in step S505 can be extracted in the second region extraction in step S506, information about the corresponding region can be collected and used as data to be extracted in the first region extraction.

The Register button 902 is used to register information for the preview masking regions 612. When the display control unit 428 detects a press of the Register button 902, the display control unit 428 transmits the information about the preview masking regions 612 in association with the layer type to the external storage 120 via the Internet accessing unit 426. The display control unit 428 may store the corresponding information in the HDD 214 via the internal data storage unit 412. The region(s) in the transmitted information is or are used in subsequent region extractions. For example, if a region in the transmitted information belongs to the fixed region layer, a new format for using the corresponding region as a masking target region can be generated and added as a format usable in the first region extraction. This enables adding a format including a region not extracted in the first region extraction, thus improving the extraction accuracy in subsequent region extractions. For example, if a region in the transmitted information belongs to the dynamic region layer, a model to be used for the second region extraction can be subjected to re-learning. The information transmitted to the external storage 120 is applicable to any other applications.

The present exemplary embodiment enables using information about a region extracted in the second region extraction for extracting character string regions having target attributes and information about a region extracted in the second region extraction and then corrected, as learning data to be used in the first region extraction for extracting regions by using the format of a form.

The present exemplary embodiment also enables using information about a region extracted in the first region extraction, and information about a region extracted in the first region extraction and then corrected, as learning data to be used in the second region extraction. This provides improved accuracy of the region extraction by the extraction type. If a region not extracted for one extraction type is complemented with a region extracted for a different extraction type, the accuracy of the region extraction is expected to be continuously improved, by correcting regions based on these pieces of information and collecting the corrected information as learning data.

The present disclosure has been described above together with exemplary embodiments. The above-described exemplary embodiments are to be merely considered to be illustrative in embodying the present disclosure, and are not to be interpreted as restrictive on the technical scope of the present disclosure. The present disclosure may be implemented in diverse forms without departing from the technical concepts or principal characteristics thereof.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-022656, filed Feb. 19, 2024, which is hereby incorporated by reference herein in its entirety.

What is claimed is:

1. An information processing apparatus comprises:
at least one memory that stores instructions; and
at least one processor that executes the instructions to perform:
extracting a first region as a masking target from a document image based on a predetermined format;
extracting a second region as a character string having a masking target attribute from the document image;
extracting, in a case where position coordinates of the first region overlap position coordinates of the second region, a third region based on the position coordinates of the first region and the position coordinates of the second region;
determining a masking target region in the document image based on the first region, the second region, and the third region; and
generating a masked image by masking the determined masking target region on the document image.

2. The information processing apparatus according to claim 1,
wherein the at least one processor executes the instructions to further perform displaying, on a screen, the first region, the second region, and the third region in the document image as masking target region candidates, and
wherein the regions displayed as the candidates are distinguishable as the first region, the second region, and the third region.

3. The information processing apparatus according to claim 2, wherein the at least one processor executes the instructions to further perform:
presenting a correction method for correcting the regions displayed as the masking target region candidates; and
upon selection of one of the regions displayed as the masking target region candidates, making the correction method to be presented different according to whether the selected region is the first region, the second region, or the third region.

4. The information processing apparatus according to claim 1, wherein the third region is a region obtained by taking a logical sum of the first region and the second region.

5. The information processing apparatus according to claim 1, wherein the third region is a region obtained by taking a circumscribed rectangle including the first region and the second region.

6. The information processing apparatus according to claim 1, wherein the third region is a region obtained by excluding a part including no character string from the circumscribed rectangle including the first region and the second region.

7. The information processing apparatus according to claim 1, wherein the third region is a region obtained by using a method specified by a user, out of a method for extracting a region by taking a logical sum of the first region and the second region, a method for extracting a region by taking a circumscribed rectangle including the first region and the second region, and a method for extracting a region by excluding a part including no character string from the circumscribed rectangle including the first region and the second region.

8. The information processing apparatus according to claim 3, wherein the at least one processor executes the instructions to further perform displaying, when the selected region is the first region, a user interface (UI) for correcting a format related to the first region.

9. The information processing apparatus according to claim 3, wherein the at least one processor executes the instructions to further perform displaying, when the selected region is the second region, a UI for correcting the attribute of the character string as the masking target.

10. The information processing apparatus according to claim 3, wherein the at least one processor executes the instructions to further perform displaying, when the selected region is the third region, a UI for correcting a method for extracting the third region.

11. The information processing apparatus according to claim 2, wherein the at least one processor executes the instructions to further perform distinguishably displaying a part derived from the first region and a part derived from the second region on the third region.

12. The information processing apparatus according to claim 1,
wherein the at least one processor executes the instructions to further perform collecting information about the first region, information about the second region, and information about the third region each associated with a corresponding group of different groups, and
wherein, in the information collection, a region selected by a user is collected as information about a group other than the group corresponding to the region.

13. An information processing method comprising:
extracting a first region as a masking target from a document image based on a predetermined format;
extracting a second region as a character string having a masking target attribute from the document image;
extracting, in a case where position coordinates of the first region overlap position coordinates of the second region, a third region based on the position coordinates of the first region and the position coordinates of the second region;
determining a masking target region in the document image based on the first region, the second region, and the third region; and
generating a masked image by masking the determined masking target region on the document image.

14. A non-transitory computer-readable storage medium that stores instructions, wherein the instructions cause at least one processor to:
extract a first region as a masking target from a document image based on a predetermined format;
extract a second region as a character string having a masking target attribute from the document image;
extract, in a case where position coordinates of the first region overlap position coordinates of the second region, a third region based on the position coordinates of the first region and the position coordinates of the second region;
determine a masking target region in the document image based on the first region, the second region, and the third region; and
generate a masked image by masking the determined masking target region on the document image.
